(19) United States
(12) Patent Application Publication
(10) Pub. No.: US 2026/0184863 A1
(43) Pub. Date: Jul. 2, 2026

(54) SILICONE ELASTOMER FOR HVDC

(71) Applicant: Wacker Chemie AG, Munich (DE)

(72) Inventors: Konrad HINDELANG, Schongau (DE); Tamara ASSMANN, Triftern (DE); Jens LAMBRECHT, Altötting (DE); Mathias MIEDL, Polling (DE)

(73) Assignee: Wacker Chemie AG, Munich (DE)

(21) Appl. No.: 18/867,059

(22) PCT Filed: Jul. 6, 2022
(86) PCT No.: PCT/EP2022/068672

§ 371 Date: Nov. 19, 2024

(51) Int. Cl. C08J 3/24; C08K 5/14; C08K 7/26; H01B 3/46

(52) U.S. Cl. CPC C08J 3/247; C08K 5/14; C08K 7/26; H01B 3/46; C08J 2383/07; C08K 2201/006

(57) ABSTRACT

A crosslinked silicone elastomer has a volume resistance adjusted to the volume resistance of an adjacent cable insulation. The crosslinked silicone elastomer is obtainable by crosslinking a base composition including (A) 50% to 99% by weight of at least one diorganopolysiloxane having at least 2 crosslinkable groups per molecule, (B) 0.5% to 5% by weight of at least one peroxide, (C) 0% to 50% by weight of at least one reinforcing filler, and (X) NO conductive or semiconductive additives. The amount of all the components adding up to 100% by weight. The base composition being applied to a substrate or filled into a mold.

The present invention relates to a crosslinked silicone elastomer, to a method for producing it, and to its use in HVDC (high voltage direct current) systems.

### PRIOR ART

Power can be transmitted substantially more cost-effectively over long distances by means of HVDC than by means of HVAC (high voltage alternating current) systems, as it entails smaller electrical losses. Particularly in the case of long-distance underground HVDC, cable connections have to be used at a high rate, namely every 1 to 2 km.

The insulating materials which are used in high voltage alternating current systems, however, usually cannot be utilized in HVDC systems, as the electrical stress for alternating and direct current conditions may be significantly different.

The local distribution of the electrical field in HVDC applications is determined via the volume resistivities of the electrical insulating materials used. In the prior art, therefore, these cable connections predominantly use EPDM (ethylene-propylene-diene rubber), as the resistance of that material comes in below that of polyolefin-based insulating materials for the cables.

EPDM, because it is hard and uses a multiplicity of fillers (impurities), displays behavior which is often a disadvantage in the context of assembly and operation.

Silicone elastomers have not hitherto been used for HVDC applications, as their resistance is too high compared with the cable insulation material.

In the prior art, therefore, electrically conductive fillers (e.g., metal powders, metal flakes, carbon blacks or carbon nanotubes) are used in order to adjust the resistance of the cured silicone elastomer. Fillers of these kinds can throw up additional problems, since it is nigh on impossible to distribute these fillers uniformly in the material in the mixing process, because of the very small quantity, to then give uniform electrical properties within the cured silicone elastomer. They lead, moreover, to a deterioration in the physical properties and to reduced dielectric strength of the cured silicone elastomer.

WO2021195038A1 discloses silicone compositions containing silica fillers which have undergone partial surface treatment with fluorinated hydrophobizing treatment agents. The high costs of the raw materials are a substantial disadvantage here.

Disadvantages evident in the systems known from the prior art are, in summary, as follows:

The disadvantage of filled systems lies first in the reproducibility (e.g., steep drop in the resistance in the region of the percolation threshold), secondly in their possible anisotropic effect (metal oxides on platelet like carrier systems) and the dependence thereof on the humidity.

Fluorinated systems are fundamentally very cost-intensive, and halogenated polymers ought fundamentally to be avoided as far as possible, for environmental reasons.

Mixtures based on EPDM are hard and difficult to work with and to install.

There is therefore a great need for silicone compositions for the production of silicone elastomers for HVDC applications that do not exhibit the above-stated disadvantages of the prior art.

It has surprisingly been found that the present crosslinked silicone elastomers of the invention durably exhibit the necessary lowering of the electrical resistance.

The present invention accordingly provides crosslinked silicone elastomers having a volume resistance adjusted to the volume resistance of an adjacent cable insulation, this volume resistance being determined on a crosslinked silicone elastomer 0.5 mm thick, in a heatable guard ring arrangement with an electrical field strength of 1 kV/mm, in accordance with standard IEC 62631-3-1 and meeting the following value after application of the test voltage:
after 10 000 minutes: <1.0 10¹⁶ ohm*cm,
   obtainable by crosslinking a base composition containing:
(A) 50% to 99% by weight of at least one diorganopolysiloxane having at least 2 crosslinkable groups per molecule,
(B) 0.5% to 5% by weight of at least one peroxide,
(C) 0% to 50% by weight of at least one reinforcing filler, and
(X) NO conductive or semiconductive additives,
the amount of all the components adding up to 100% by weight,
   wherein this base composition
is applied to a substrate or filled into a mold,
in a first step, crosslinking takes place by heating to at least the temperature of the 10 h HLT (=10 hour half-life temperature) of the peroxide (B), the heating duration corresponding to at least 0.2 of an HL (=half-life) of the peroxide (B) at the chosen crosslinking temperature,
in a second step, heat treatment takes place above the temperature of the 10 h HLT of the peroxide (B), the heat treatment duration corresponding to at least one HL of the peroxide (B) at the chosen heat treatment temperature.

In order not to make the number of pages in the description of the present invention too extensive, only the preferred embodiments of the individual features are set out below. However, the learned reader is to explicitly understand this nature of the disclosure such that any combination of different preference stages is therefore also explicitly disclosed and explicitly desired.

The volume resistance of these crosslinked silicone elastomers of the invention is
after 1 minute: <1.0 10¹⁵ ohm*cm; preferably <8.0 10¹⁴ ohm*cm; more preferably <5.0 10¹⁴ ohm*cm;
after 15 minutes: <3.0 10¹⁵ ohm*cm; preferably <2.0 10¹⁵ ohm*cm; more preferably <8.0 10¹⁴ ohm*cm;
after 10 000 minutes: <1.0 10¹⁶ ohm*cm; preferably <8.0 10¹⁵ ohm*cm; more preferably <6.0 10¹⁵ ohm*cm.

Energy sources used for the crosslinking and heat treatment are preferably ovens, e.g., forced air drying cabinets, heating tunnels, heated rolls, heated plates, heated molds, or thermal radiation in the infrared range.

It has emerged that the volume resistance of the cured silicone elastomers of the invention can be robustly adjusted only through the amount of peroxide (B) in accordance with the invention, in combination with the crosslinking and heat treatment conditions of the invention, despite forgoing the use of conductive or semiconductive additives (X). Flexible silicone elastomers can be produced with advantageous properties (resistance to electrical aging, gas permeability, translucency, elasticity over wide temperature ranges) that are already established in alternating voltage applications by comparison with other materials. This possibility in the invention of now robustly adjusting the volume resistance as well makes it presently possible to utilize these advantages for direct current applications as well.

### Volume Resistance Measurement Method:

Measurement takes place on a crosslinked silicone elastomer 0.5 mm thick, in a heatable guard ring arrangement with an electrical field strength of 1 kV/mm, in accordance with standard IEC 62631-3-1 “Guidelines for the determination of dielectric and resistive properties of solid insulating materials—Part 3-1: Determination of resistive properties (DC Methods)—Volume resistance and volume resistivity, general method”.

Measuring devices used are guard ring measuring cells from Tettex Instruments “Solid Test Cell 2914” with an “Eaton Sefelec 1500-M” or Sefelec M1501 P megohmmeter.

The volume resistance was measured and the volume resistivity calculated from it.

The heating duration of the crosslinking in the first step takes place preferably for at least one HL of the peroxide (B) at the chosen crosslinking temperature, more preferably for at least two HLs of the peroxide (B) at the chosen crosslinking temperature.

In one preferred embodiment, the crosslinking in the first step takes place at a temperature of at least the 10 h HLT (=10 hour half-life temperature) to at most the 1 min HLT (=1 minute half-life temperature) of the peroxide (B) used, more preferably at a temperature of at least the 10 h HLT to at most 10° C. below the 1 min HLT of the peroxide (B) used.

### Component (A)

Constituent (A) of the composition of the invention is a diorganopolysiloxane or a mixture of diorganopolysiloxanes of the general formula (1):

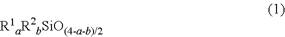

R¹ is a substituted or unsubstituted monovalent hydrocarbon radical which contains no aliphatically unsaturated groups. R² is a substituted or unsubstituted monovalent hydrocarbon radical which is aliphatically unsaturated.

The indices a and b are positive numbers in the range 1≤a<3, 0≤b≤1, and 1<a+b≤3.

In one preferred embodiment, each molecule contains on average at least two unsaturated groups R² bonded to silicon atoms.

In particular, R¹ is a monovalent, SiC-bonded, optionally substituted hydrocarbon radical having 1 to 18 carbon atoms which is free from aliphatic carbon-carbon multiple bonds.

Examples of radicals R¹ are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical; cycloalkyl radicals, such as cyclopentyl, cyclohexyl, cycloheptyl and methylcyclohexyl radicals; aryl radicals, such as the phenyl, naphthyl, anthryl and phenanthryl radical; alkaryl radicals, such as o-, m-, p-tolyl radicals, xylyl radicals and ethylphenyl radicals; and aralkyl radicals, such as the benzyl radical, the α- and the β-phenylethyl radical.

Examples of substituted radicals R¹ are haloalkyl radicals, such as the 3,3,3-trifluoro-n-propyl radical, the 2,2,2,2′,2′,2′-hexafluoroisopropyl radical, the heptafluoroisopropyl radical, and haloaryl radicals, such as the o-, m- and p-chlorophenyl radical, and all the radicals stated above for R which may be substituted preferably by mercapto groups, epoxy-functional groups, carboxyl groups, keto groups, enamine groups, amino groups, aminoethylamino groups, isocyanato groups, aryloxy groups, acryloyloxy groups, methacryloyloxy groups, hydroxyl groups and halogen groups.

The radical R¹ is preferably a monovalent hydrocarbon radical having 1 to 6 carbon atoms, the methyl radical being more preferred.

R² is in particular a monovalent SiC-bonded hydrocarbon radical having aliphatic carbon-carbon multiple bonding.

Examples of radicals R² are alkenyl radicals, such as the vinyl, 5-hexenyl, cyclohexenyl, 1-propenyl, allyl, 3-butenyl and 4-pentenyl radical, and alkynyl radicals, such as the ethynyl, propargyl and 1-propynyl radical.

The radical R² is preferably alkenyl radicals, the vinyl radical being more preferred.

In one preferred embodiment, R¹ is a methyl group and R² is a vinyl group. The structure of the diorganopolysiloxanes (A) may be linear or branched, a linear structure being preferred. The viscosity of the diorganopolysiloxanes (A) at 25° C. (determined according to DIN 53018) is between 1000 mPa·s and 50 000 000 mPa·s. In one preferred embodiment, the viscosity of the diorganopolysiloxanes (A) is between 500 000 and 40 000 000 mPa·s, more preferably still between 2 000 000 and 30 000 000 mPa·s, and is therefore in the region of the polysiloxanes used typically in high temperature vulcanizing (i.e., crosslinking; HTV) rubbers.

In another embodiment, the viscosity of the diorganopolysiloxanes (A) at 25° C. (determined according to DIN 53018) is preferably between 1000 mPa·s and 100 000 mPa·s, more preferably still between 5000 and 50 000 mPa·s. Polysiloxanes in this viscosity range are used typically for liquid silicone rubbers (LSR).

The diorganopolysiloxanes (A) may for example be vinyl-terminated polydimethylsiloxanes, vinyl-terminated polydimethyl-polymethylvinyl-siloxanes or trimethylsilyl-terminated polydimethyl-polymethylvinyl-siloxanes. Component (A) may consist of a single diorganopolysiloxane or of mixtures of two or more diorganopolysiloxanes.

(A) is used in amounts of 50% by weight to 99% by weight, preferably 55% by weight to 85% by weight, more particularly 60% by weight to 80% by weight.

### Component (B)

Crosslinkers used are peroxides, which serve as a source of free radicals. They are selected from the group of the dialkyl peroxides, diaryl peroxides, alkyl aryl peroxides, aralkyl peroxides and hydroperoxides. A single peroxide or hydroperoxide may be used as component (B), or a combination of different peroxides or of peroxides with hydroperoxides.

Examples of organic peroxides are acyl peroxides, such as dibenzoylperoxide, bis(4-chlorobenzoyl) peroxide, bis(2,4-dichlorobenzoyl) peroxide and bis(4-methylbenzoyl) peroxide; alkyl peroxides and aryl peroxides, such as di-tert-butyl peroxide, 2,5-bis(tert-butylperoxy)-2,5-dimethylhexane, dicumyl peroxide and 1,3-bis(tert-butylperoxyisopropyl)benzene; perketals, such as 1,1-bis(tert-butylperoxy)-3,3,5-trimethylcyclohexane; peresters, such as diacetyl peroxydicarbonate, tert-butyl perbenzoate, tert-butyl peroxyisopropyl carbonate, tert-butyl peroxyisononanoate, dicyclohexyl peroxydicarbonate and 2,5-dimethylhexane-2,5-diperbenzoate.

In the prior art, it is known that peroxides may be differentiated as vinyl-specific and non-vinyl-specific peroxides. See, for example, the textbook SILICONES by Pachaly et al., WILEY-CH, ISBN-10:3-527-30770-2, ISBN-13:978-3527-30770-8; pages 41 ﬀ.

(B) is used in amounts of 0.5% to 5% by weight, preferably of 1% to 4% by weight, especially preferably of 1.5% to 3% by weight.

Peroxides have Characteristics:

### The Half-Life (HL):

The HL of a peroxide at a defined temperature indicates the time after which half of the amount of peroxide has decayed.

Data on half-lives are found in the literature, and they are provided by peroxide producers. Values between individual data points can be extrapolated via Arrhenius kinetics.

### 10 h HLT:

The 10 hour half-life temperature is the temperature at which half of the amount of peroxide has decayed within 10 hours.

### 1 min HLT:

The 1 minute half-life temperature is the temperature at which half of the amount of peroxide has decayed within one minute.

In one preferred embodiment, a vinyl-containing diorganopolysiloxane is used as component (A) and a vinyl-specific peroxide as component (B).

### Reinforcing Fillers (C)

Reinforcing fillers (C) which can be used are fumed or precipitated silicas having BET surface areas of at least 50 m²/g.

The stated actively reinforcing silica fillers (C) may have hydrophilic character or may have been hydrophobized by known methods.

Preferred are precipitated and fumed silicas and also mixtures thereof. Particularly preferred are fumed silica surface-treated with silylating agent. The hydrophobizing techniques have been known for a long time in the prior art to the skilled person. The silica may be hydrophobized either before incorporation into the polyorganosiloxane or else in the presence of a polyorganosiloxane, by the in situ method. Both methods may be performed either as the batch operation or else continuously. Silylating agents used may be all of the hydrophobizing agents known to the skilled person. These are, preferably, silazanes, more particularly hexamethyldisilazane and/or 1,3-divinyl-1,1,3,3-tetramethyldisilazane, and/or polysilazanes, where additionally water may also be used. It is also possible, additionally, to use other silylating agents, such as, for example, SiOH— and/or SiCl— and/or alkoxy-functional silanes and/or siloxanes as hydrophobizing agents. It is also possible to use cyclic, linear or branched non-functional organosiloxanes, such as, for example, octamethylcyclotetrasiloxane or polydimethylsiloxane, in each case on its own or additionally to silazanes, as silylating agents. To accelerate hydrophobizing, a further possibility is to add catalytically active additives, such as hydroxides, for example. Hydrophobizing may take place in one step using one or more hydrophobizing agents, or else using one or more hydrophobizing agents in multiple steps.

Preferred are precipitated or fumed silicas. More preferred is a silica having a BET specific surface area of 80-400²/g, more preferably 100-400 m²/g.

Actively reinforcing silica fillers (C) may be used individually or as mixtures.

The amount of reinforcing filler (C) is in the range from 0% to 50% by weight, preferably at 15% to 45% by weight, more preferably at 20% to 40% by weight.

### Further Constituents (D)

Further constituents which may be used in the context of the compositions of the invention have been known for a long time from the prior art to the skilled person. Nonlimiting examples include nonreinforcing fillers, plasticizers, adhesion promoters, soluble dyes, inorganic and organic pigments, solvents, fungicides, fragrances, dispersing assistants, rheological additives, corrosion inhibitors, antioxidants, light stabilizers, heat stabilizers, flame retardants.

### Constituent (X)

There are NO conductive or semiconductive additives (X) included in the base composition of the invention. NO means that such additives may, however, be included at up to the order of magnitude typical of impurities. Additives of these kinds have been known for a long time to the skilled person. Examples are carbon blacks, metals, metal oxides, semiconductors (e.g., SiC, Si) in the form of nanoparticles.

Additionally provided by the present invention is the method for producing the crosslinked silicone elastomers of the invention having a volume resistance which is adjusted to the volume resistance of an adjacent cable insulation,

this volume resistance being determined on a crosslinked silicone elastomer 0.5 mm thick, in a heatable guard ring arrangement with an electrical field strength of 1 kV/mm, in accordance with standard IEC 62631-3-1 and meeting the following value after application of the test voltage:
after 10 000 minutes: <1.0 1016 ohm*cm,
   obtainable by crosslinking a base composition containing:
(A) 50% to 99% by weight of at least one diorganopolysiloxane
having at least 2 crosslinkable groups per molecule,
(B) 0.5% to 5% by weight of at least one peroxide,
(C) 0% to 50% by weight of at least one reinforcing filler,
and
(X) NO conductive or semiconductive additives,
the amount of all the components adding up to 100% by weight,
wherein this base composition
   is applied to a substrate or filled into a mold,
   in a first step, crosslinking takes place by heating to at least the temperature of the 10 h HLT (=10 hour half-life temperature) of the peroxide (B), the heating duration corresponding to at least 0.2 of an HL (=half-life) of the peroxide (B) at the chosen crosslinking temperature,
   in a second step, heat treatment takes place above the temperature of the 10 h HLT of the peroxide (B), the heat treatment duration corresponding to at least one HL of the peroxide (B) at the chosen heat treatment temperature.

Additionally provided by the present invention is the use of crosslinked silicone elastomers for insulation applications, more particularly for HVDC applications such as HVDC fittings.

### EXAMPLES

The examples which follow describe the fundamental possibility of implementing the present invention, but without limiting the latter to the content disclosed therein.

In the examples which follow, all figures for parts and percentages, unless otherwise indicated, are based on weight. Unless otherwise indicated, the following examples are carried out at a pressure of the surrounding atmosphere, in other words at about 1000 hPa, and at room temperature, in other words about 20° C., or at a temperature which comes about when the reactants are combined at room temperature without additional heating or cooling.

The composition of the invention may be produced by simple mixing of the constituents in a mixing assembly typically used for silicone rubber compositions (cross arm stirrer, paddle stirrer, compounder, extruder, two-roll mill).

In the text below and in the tables:

$$E 13 = 1 {0}^{13}$$

$$E 14 = {10}^{14}$$

$$E 15 = {10}^{15}$$

$$E 16 = {10}^{16}$$

$$HL = half - life$$

### Peroxides=Crosslinkers

Crosslinker 1: Crosslinker 1 is dicumyl peroxide with characteristics as follows:
10 h HLT: 111° C.
1 min HLT: 168° C.
Half-life at 120° C.: ˜5.3 hours
Half-life at 130° C.: ˜1.6 hours
Half-life at 140° C.: ˜0.5 hour
Half-life at 165° C.: ˜1.5 minutes

Crosslinker 2: Crosslinker 2 is a 50% paste of 2,5-dimethyl-2,5-bis(tert-butylperoxy)hexane in silicone oil, with characteristics as follows:
10 h HLT: 116° C.
1 min HLT: 176° C.

Crosslinker 3: Crosslinker 3 is a 50% paste of bis(4-methylbenzoyl) peroxide in silicone oil.
10 h HLT: 70° C.
1 min HLT: 130° C.

Crosslinker 4: Crosslinker 4 is a 50% paste of bis(2,4-dichlorobenzoyl) peroxide with characteristics as follows:
10 h HLT: 51° C.
1 min HLT: 119° C.

### Base Composition 1:

In a laboratory compounder, 750 g of a vinyldimethylsiloxy-terminated polydimethylsiloxane (PDMS) having a viscosity of 20 000 mPas (25° C.) were initially introduced, heated to 150° C., and admixed with 550 g of a hydrophobic fumed silica having a BET specific surface area of 300 m²/g and a carbon content of 3.9% by weight. This gave a composition of high viscosity which was subsequently diluted with 300 g of a vinyldimethylsiloxy-terminated polydimethylsiloxane having a viscosity of 20 000 mPas (25° C.). Kneading was carried out under reduced pressure (10 mbar) at 150° C. over the course of an hour to remove volatile constituents.

### Base Composition 2:

In a compounder, 100 parts of a dimethylvinylsilyloxy-terminated dimethylsiloxane-methylvinylsiloxane copolymer, containing 99.94 mol % dimethylsiloxy units and 0.06 mol % methylvinylsiloxy units and having a degree of polymerization of about 6000 siloxy units, were mixed with 41 parts of silica having a surface area, measured according to the BET technique, of 300 m²/g and with 7 parts of a dimethylhydroxysiloxy-terminated dimethylsiloxane oligomer having a viscosity of 40 mPa·s until the mixture was homogeneous, followed by heating at 170° C. for two hours.

### Example 1 (Not According to the Invention)

80.0 g of the base composition 1 were admixed at 25° C. with 18.7 g of vinyldimethylsiloxy-terminated polydimethylsiloxane having a viscosity of 20 000 mPa·s (25° C.), 0.1 g of ethynylcyclohexanol, 1.9 g of a copolymer composed of dimethylsiloxy, methylhydrogensiloxy and trimethylsiloxy units and having a viscosity of 300 mPa·s at 25° C. and an SiH content of 0.47%, and 0.1 g of a solution containing a platinum-sym-divinyltetramethyldisiloxane complex and 1% by weight platinum. The composition was mixed homogeneously with a paddle stirrer and then degassed in a desiccator (10 min at about 10 mbar).

The silicone composition produced in this way was subsequently crosslinked in a hydraulic press in line with the time and temperature indicated in the table. After demolding, silicone elastomer films 0.5 mm thick were heat treated in a forced air oven in line with the conditions indicated in the table. Subsequently, the volume resistance was determined according to the technique described.

TABLE 1
Processing conditions and data on the volume
resistance for Example 1 a) and b)

| | Example 1 a) | Example 1 b) |
|---|---|---|
| Crosslinking | 5 min, 165° C. | 30 min, 100° C. |
| Heat treatment | 4 h, 200° C. | 24 h, 120° C. |
| Volume resistance after | 2.8E15 | 3.3E15 |
| 1 min in ohm · cm | | |
| Volume resistance after | 6.0E15 | 5.7E15 |
| 15 min in ohm · cm | | |
| Volume resistance after | 4.1E16 | 3.6E16 |
| 10 000 min in ohm · cm | | |

### Example 2

80.0 g of the base composition 1 were admixed at 25° C. with 20.0 g of vinyldimethylsiloxy-terminated polydimethylsiloxane having a viscosity of 20 000 mPa·s (25° C.) and with the amount of peroxide indicated in Table 2. The composition was mixed homogeneously with a paddle stirrer and then degassed in a desiccator (10 min at about 10 mbar).

The silicone composition produced in this way was subsequently crosslinked in a hydraulic press in line with the time and temperature indicated in Table 2. After demolding, silicone elastomer films 0.5 mm thick were heat treated in a forced air oven in line with the conditions indicated in the table. Subsequently, the volume resistance was determined according to the technique described.

TABLE 2
Amount of peroxide, processing conditions and
volume resistance for Example 2 a) to 2c)

| | Example 2a | Example 2b | Example 2c |
|---|---|---|---|
| Crosslinker 1 | 0.6 g | 2.0 g | 3.0 g |
| Crosslinking | 15 min | 15 min | 15 min |
| | 165° C. | 165° C. | 165° C. |
| Heat treatment | 24 h | 24 h | 24 h |
| | 120° C. | 120° C. | 120° C. |
| Volume resistance after | 5.3E14 | 1.1E14 | 4.5E13 |
| 1 min in ohm · cm | | | |
| Volume resistance after | 1.1E15 | 2.6E14 | 1.2E14 |
| 15 min in ohm · cm | | | |
| Volume resistance after | 5.5E15 | 1.3E15 | 6.8E14 |
| 10 000 min in ohm · cm | | | |

### Example 3

80.0 g of the base composition 1 were admixed at 25° C. with 20.0 g of vinyldimethylsiloxy-terminated polydimethylsiloxane having a viscosity of 20 000 mPa·s (2500) and with the amount of peroxide indicated in Table 3. The composition was mixed homogeneously with a paddle stirrer and then degassed in a desiccator (10 min at about 10 mbar).

The silicone composition produced in this way was subsequently crosslinked in a hydraulic press in line with the time and temperature indicated in Table 3. After demolding, silicone elastomer films 0.5 mm thick were heat treated in a forced air oven in line with the conditions indicated in the table. Subsequently, the volume resistance was determined according to the technique described.

TABLE 3
Type and amount of peroxide, processing conditions and volume
resistance (stated in ohm.cm) for Example 3 a) to 3 c)

| | Example 3a | Example 3b | Example 3c |
|---|---|---|---|
| Crosslinker 1 | 2.0 g | — | — |
| Crosslinker 2 | — | 4.0 g | — |
| | | (corresponding to | |
| | | 2.0 g of pure | |
| | | peroxide) | |
| Crosslinker 3 | — | — | 2.0 g |
| | | | (corresponding |
| | | | to 1.0 g of pure |
| | | | peroxide) |
| Crosslinking | 16 h 130° C. | 16 h 130° C. | 16 h 130° C. |
| Heat treatment | 24 h 120° C. | 24 h 120° C. | 24 h 120° C. |
| Volume resistance | 5.4E13 | 7.4E13 | 7.2E14 |
| after 1 min in | | | |
| ohm · cm | | | |
| Volume resistance | 1.5E14 | 1.3E14 | 1.6E15 |
| after 15 min | | | |
| in ohm · cm | | | |
| Volume resistance | 8.2E14 | 7.2E14 | 8.1E15 |
| after 10 000 min | | | |
| in ohm · cm | | | |

### Example 4

The constituents indicated in Table 4 were mixed homogeneously with a paddle stirrer and then degassed in a desiccator (10 min at about 10 mbar).

The silicone composition produced in this way was subsequently crosslinked in a hydraulic press in line with the time and temperature indicated in Table 4. After demolding, silicone elastomer films 0.5 mm thick were heat treated in a forced air oven in line with the conditions indicated in Table 4. Subsequently, the volume resistance was determined.

TABLE 4
Composition, processing conditions and volume resistance
(stated in ohm.cm) for Example 4 a) to 4 d)

| | Example | Example | Example | Example |
|---|---|---|---|---|
| | 4a | 4b | 4c | 4d |
| Base composition 1 | 100.0 g | 50.0 g | 0 | 80.0 g |
| Vinyl-terminated | 0 | 50.0 g | 100.0 g | |
| PDMS; viscosity 20 | | | | |
| 000 mPa · s | | | | |
| Trimethylsilyl-ter- | 0 | | | 20.0 g |
| minated PDMS with | | | | |
| viscosity 100 | | | | |
| mPa · s (25° C.) | | | | |
| Crosslinker 1 | 2.0 g | | 2.0 g | 2.0 g |
| Crosslinker 2 | | 4.0 g | | |
| Crosslinking | 15 min | 15 min | 15 min | 16 h |
| | 165° C. | 165° C. | 165° C. | 130° C. |
| Heat treatment | 24 h | 4 h | 24 h | 24 h |
| | 140° C. | 200° C. | 140° C. | 120° C. |
| Volume resistance | 7.0E13 | 4.0E14 | 6.8E14 | 3.0E13 |
| after 1 min in | | | | |
| ohm · cm | | | | |
| Volume resistance | 1.8E14 | 8.2E14 | 1.2E15 | 8.7E13 |
| after 15 min in | | | | |
| ohm · cm | | | | |
| Volume resistance | 1.0E15 | 4.1E15 | 2.8E15 | 6.8E14 |
| after 10 000 min in | | | | |
| ohm · cm | | | | |

### Example 5

A mixture of 100 g of the base composition 2 and 4.0 g of crosslinker 2 was produced on a roll. The silicone composition produced in this way was subsequently crosslinked in a hydraulic press at 165° C. for 15 minutes. After demolding, silicone elastomer films 0.5 mm thick were heat treated in a forced air oven for 4 hours at 20000. Subsequently, the volume resistance was determined according to the technique described.

### Example 6

A mixture of 100 g of a polydimethylsiloxane having a degree of polymerization of about 6000 siloxy units and 1.5 g of crosslinker 4 was produced on a roll. The silicone composition produced in this way was subsequently crosslinked in a hydraulic press at 165° C. for 15 minutes. After demolding, silicone elastomer films 0.5 mm thick were heat treated in a forced air oven for 8 hours at 20000. Subsequently, the volume resistance was determined according to the technique described.

TABLE 5
Volume resistance for Example 5 and Example 6

| | Example 5 | Example 6 |
|---|---|---|
| Volume resistance | 3.1E14 | 4.7E14 |
| after 1 min | | |
| in ohm · cm | | |
| Volume resistance | 6.6E14 | 8.6E14 |
| after 15 min in ohm · cm | | |
| Volume resistance | 3.4E15 | 3.0E15 |
| after 10 000 min in | | |
| ohm · cm | | |

### Example 7

80.0 g of the base composition 1 were admixed at 25° C. with 20.0 g of vinyldimethylsiloxy-terminated polydimethylsiloxane having a viscosity of 20 000 mPa·s (2500) and with 2.0 g of crosslinker 1. The composition was mixed homogeneously with a paddle stirrer and then degassed in a desiccator (10 me at about 10 mbar).

The silicone composition produced in this way was subsequently crosslinked in a hydraulic press in line with the time and temperature indicated in the table. After demolding, silicone elastomer films 0.5 mm thick were heat treated in a forced air oven in line with the conditions indicated in the table. Subsequently, the volume resistance was determined according to the technique described.

TABLE 6
Processing conditions and volume resistances
for Example 7 a)-d) and 7e)-g)

| | Example | Example | Example | Example |
|---|---|---|---|---|
| | 7a | 7b | 70 | 7d |
| Crosslinking | 130° C. | 130° C. | 130° C. | 130° C. |
| | 30 minutes | 2 hours | 4 hours | 16 hours |
| | (~ 0.3 | (1.25 | (2.5 | (10 |
| | times HL) | times HL) | times HL) | times HL) |
| Heat treatment | 24 h | 24 h | 24 h | 24 h 120° C. |
| | 120° C. | 120° C. | 120° C. | |
| Volume resistance | 1.0E15 | 2.0E14 | 7.2E13 | 7.2E13 |
| after 1 min | | | | |
| in ohm · cm | | | | |
| Volume resistance | 1.9E15 | 7.1E14 | 2.5E14 | 1.4E14 |
| after 15 min in | | | | |
| ohm · cm | | | | |
| Volume resistance | 8.2E15 | 4.9E15 | 2.1E15 | 9.0E14 |
| after 10 000 min | | | | |
| in ohm · cm | | | | |

| | Example | Example | |
|---|---|---|---|
| | 7e | 7f | Example 7 |
| Crosslinking | 140° C. | 140° C. | 140° C. |
| | 30 minu- | 1 | 2 hours |
| | tes | hour (2 | (4 times |
| | (~ 1 times | times HL) | HL) |
| | HL) | | |
| Heat treatment | 24 h | 24 h | 24 h |
| | 120° C. | 120° C. | 120° C. |
| Volume resistance after | 4.3E14 | 1.3E14 | 4.5E13 |
| 1 min | | | |
| in ohm · cm | | | |
| Volume resistance after | 9.1E14 | 2.9E14 | 1.6E14 |
| 15 min in ohm · cm | | | |
| Volume resistance after 10 | 6.1E15 | 2.0E15 | 1.1E15 |
| 000 min in ohm · cm | | | |

### Example 8

The test plate from Example 7 c), after the determination of the volume resistance, was packed tight in aluminum foil and stored at 8000. After the storage time indicated in the table, the test plate was removed from the oven and the volume resistance value (15 min measurement) was ascertained. The plate was subsequently packed in aluminum foil again and stored further at 8000.

TABLE 7
Storage time and volume resistance for Example 8.

| | Volume resistance after 15 min in |
|---|---|
| Storage time (hours) | ohm · cm |
| 0 | 3.7E14 |
| 168 | 3.5E14 |
| 340 | 3.2E14 |
| 500 | 3.6E14 |
| 1430 | 3.8E14 |

### Example 9

The test plate from 3 a was left in the measuring cell for the volume resistance measurement and the volume resistance was measured (at 1 kV/mm and 9000) after the times indicated in Table 9.

TABLE 9
Electrothermal storage time and volume resistances
(measured at 1 kV/mm and 90° C.)

| Storage time (minutes) | Volume resistance in ohm · cm |
|---|---|
| 10 000 (see Ex. 3 a) | 8.2E14 |
| 14 400 | 8.7E14 |
| 18 750 | 8.9E14 |
| 30 150 | 8.8E14 |

TABLE 10
Composition of the examples according to the invention

| | Silicone polymer | Silica | Peroxide |
|---|---|---|---|
| Example | [% by wt.] | [% by wt.] | [% by wt.] |
| 2a | 72.1 | 27.3 | 0.6 |
| 2b | 71.0 | 27.0 | 2.0 |
| 2c | 70.4 | 26.7 | 2.9 |
| 3a | 71.0 | 27.0 | 2.0 |
| 3b | 71.6 | 26.4 | 1.9 |
| 3c | 71.0 | 27.0 | 1.0 |
| 4a | 64.3 | 33.7 | 2.0 |
| 4b | 81.6 | 16.5 | 1.9 |
| 4c | 98.0 | 0 | 2.0 |
| 4d | 71.0 | 27.0 | 2.0 |
| 5 | 71.4 | 26.6 | 1.9 |
| 6 | 97.3 | 0 | 0.7 |
| 7a, b, c, d | 71.0 | 27.0 | 2.0 |
| 8 and 9 | 71.0 | 27.0 | 2.0 |

For selected examples, test plates were fabricated in line with the conditions indicated in the examples, for the production of mechanical test specimens. The results of the measurements are summarized in Table 11. The mechanical properties were determined by means of standard measurement techniques.

TABLE 11
Mechanical properties for selected examples

| | Shore A | Tensile strength | Elongation at | Tear resistance |
|---|---|---|---|---|
| | hardness | [N/mm²] | break [%] | [N/mm] |
| 2a | 35 | 8.3 | 550 | 18 |
| 2b | 37 | 8.4 | 500 | 18 |
| 2c | 38 | 9.0 | 500 | 17 |
| 3a | 38 | 8.5 | 530 | 18 |
| 4d | 22 | 6.8 | 630 | 17 |
| 7d | 37 | 8.4 | 500 | 18 |

1-14. (canceled)

15. A crosslinked silicone elastomer having a volume resistance adjusted to the volume resistance of an adjacent cable insulation,
this volume resistance being determined on a crosslinked silicone elastomer 0.5 mm thick, in a heatable guard ring arrangement with an electrical field strength of 1 kV/mm, in accordance with standard IEC 62631-3-1 and meeting the following value after application of the test voltage:
after 10 000 minutes: <1.0 10¹⁶ ohm*cm,
obtainable by crosslinking a base composition containing:
(A) 50% to 99% by weight of at least one diorganopolysiloxane
having at least 2 crosslinkable groups per molecule,
(B) 0.5% to 5% by weight of at least one peroxide,
(C) 0% to 50% by weight of at least one reinforcing filler,
and
(X) NO conductive or semiconductive additives,
the amount of all the components adding up to 100% by weight,
wherein this base composition
is applied to a substrate or filled into a mold,
in a first step, crosslinking takes place by heating to at least the temperature of the 10 h HLT (10 hour half-life temperature) of the peroxide (B), the heating duration corresponding to at least 0.2 of an HL (=half-life) of the peroxide (B) at the chosen crosslinking temperature,
in a second step, heat treatment takes place above the temperature of the 10 h HLT of the peroxide (B), the heat treatment duration corresponding to at least one HL of the peroxide (B) at the chosen heat treatment temperature.

16. The crosslinked silicone elastomer as claimed in claim 15, wherein the heating duration of the crosslinking in the first step corresponds to at least one HL of the peroxide (B) at the chosen crosslinking temperature.

17. The crosslinked silicone elastomer as claimed in claim 15, wherein the heating duration of the crosslinking in the first step corresponds to at least two HLs of the peroxide (B) at the chosen crosslinking temperature.

18. The crosslinked silicone elastomer as claimed in claim 15, wherein the crosslinking in the first step takes place at a temperature of at least the 10 h HLT to at most the 1 min HLT (=1 minute half-life temperature) of the peroxide (B).

19. The crosslinked silicone elastomer as claimed in claim 15, wherein the crosslinking in the first step takes place at a temperature of at least the 10 h HLT to at most 10° C. below the 1 min HLT of the peroxide (B).

20. The crosslinked silicone elastomer as claimed claim 15, wherein the base composition contains as (C) 15% to 45% by weight of at least one fumed or precipitated silica having BET surface areas of at least 50 m²/g.

21. The crosslinked silicone elastomer as claimed claim 15, the elastomer having 1% to 4% by weight of at least one peroxide (B).

22. The crosslinked silicone elastomer as claimed claim 15, wherein a vinyl-containing diorganopolysiloxane is used as component (A) and a vinyl-specific peroxide as component (B).

23. The crosslinked silicone elastomer as claimed in claim 15, wherein the volume resistance is
after 10 000 minutes: <8.0 10¹⁵ ohm*cm.

24. The crosslinked silicone elastomer as claimed in claim 15, wherein the volume resistance is
after 10 000 minutes: <6.0 10¹⁵ ohm*cm.

25. A method for producing a crosslinked silicone elastomer having a volume resistance which is adjusted to the volume resistance of an adjacent cable insulation,
this volume resistance being determined on a crosslinked silicone elastomer 0.5 mm thick, in a heatable guard ring arrangement with an electrical field strength of 1 kV/mm, in accordance with standard IEC 62631-3-1 and meeting the following value after application of the test voltage:
after 10 000 minutes: <1.0 10¹⁶ ohm*cm,
obtainable by crosslinking a base composition containing:
(A) 50% to 99% by weight of at least one diorganopolysiloxane
having at least 2 crosslinkable groups per molecule,
(B) 0.5% to 5% by weight of at least one peroxide,
(C) 0% to 50% by weight of at least one reinforcing filler,
and
(X) NO conductive or semiconductive additives,
the amount of all the components adding up to 100% by weight,
wherein this base composition
is applied to a substrate or filled into a mold,
in a first step, crosslinking takes place by heating to at least the temperature of the 10 h HLT (10 hour half-life temperature) of the peroxide (B), the heating duration corresponding to at least 0.2 of an HL (=half-life) of the peroxide (B) at the chosen crosslinking temperature,
in a second step, heat treatment takes place above the temperature of the 10 h HLT of the peroxide (B), the heat treatment duration corresponding to at least one HL of the peroxide (B) at the chosen heat treatment temperature.

26. The use of the crosslinked silicone elastomer as claimed in claim 15 for insulation applications.

27. The use of the crosslinked silicone elastomer of claim 25 for insulation applications.

28. The use as claimed in claim 25 for HVDC applications.

29. The use as claimed in claim 25 for HVDC fittings.
